(19) United States
(12) Patent Application Publication
(10) Pub. No.: US 2008/0047477 A1
(43) Pub. Date: Feb. 28, 2008

(54) BOAT HULL AND BAIT TANK DESIGN

(75) Inventors: Lawrence J. Graf, Snohomish, WA (US); David Pugh, Snohomish, WA (US); David T. Livingston, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: GLACIER BAY, INC., Monroe, WA (US)

(21) Appl. No.: 11/676,119

(22) Filed: Feb. 16, 2007

Related U.S. Application Data
(60) Provisional application No. 60/773,840, filed on Feb. 16, 2006.

(51) Int. Cl. B63B 1/10; A01K 97/05; B63B 17/00; A47B 96/00

(52) U.S. Cl. 114/61.21; 114/343; 43/55; 52/27

(57) ABSTRACT

A boat hull is described that includes a plurality of features to improve stability and tracking. Any one or more of the features can be provided in a watercraft having displacement and planing characteristics. The hull features improve tracking and stability of the hull when in displacement mode and planing mode.

### CROSS-REFERENCE TO RELATED APPLICATION

This application claims the benefit of U.S. Provisional Application No. 60/773,840, filed on Feb. 16, 2006, incorporated herein expressly by reference.

### BACKGROUND

There are two general classifications for boat hull designs: displacement-type hulls and planing-type hulls. Displacement-type hulls are designed to support the weight of the vessel by displacing a volume of water equal in mass to the mass of the vessel and are specifically designed to generate a minimal amount of dynamic lift while the boat is in motion. Displacement-type hulls traditionally are used for low speed watercraft that do not exceed their theoretical hull speed, but are also used on high speed watercraft that are intended for a smooth ride in rough water. Planing-type hulls are for watercraft designed to exceed the theoretical hull speed, and support the weight of the vessel by generating dynamic lift in addition to displacing water. In simplified terms, when these two types of hulls are operating within their intended speed ranges, a planning hull skims across the top of the water while a displacement hull slices through the water. There are advantages and disadvantages to each hull type depending on the vessel's intended use. For instance, the occupants of a vessel that skims across the top of the water are subject to a jarring sensation in rough water while the occupants of a vessel that slices thru the water enjoy a significantly smoother ride. Conversely, high speed displacement vessels typically heel uncomfortably outward in sharp turns due to insufficient dynamic lift to overcome the centrifugal rolling force.

### SUMMARY

In view of the aforementioned characteristics of current boat hull designs, one embodiment of the present invention is a multi-hull design incorporating both displacement and planing hull surfaces in the same vessel. The planing surface is positioned to the outboard side of the vessel while the displacement surface is positioned to the inboard side of the vessel. In this way, the rough ride of a planing vessel is cut in half while dynamic lift is generated to maintain a comfortable banking motion in turns. The outer, upper edges of the planing and displacement hull surfaces can terminate at chines to separate them from the next adjoining surfaces.

Another embodiment is a hull having a wide shallow keel to separate the two types of hull surfaces to prevent them from unfavorably interacting with each other. Said keel has a width to height ratio of between 4 and 5 at the stern. The inner, lower edges of the planing and displacement hull surfaces can terminate at and are separated by the keel.

Another embodiment is a hull having a transition panel between the planing surface and the keel wherein the transition panel is inclined outward and upward about 40 to about 50 degrees from vertical, which further assists in counteracting the centrifugal rolling motion in turns. Said transition panel is located along the aft half of the hull where it has the most effect, tapering to its forward termination point at about amidship.

Another embodiment is a hull having a fin on the hull side that extends from the bow towards the stern for not more than 40% of the waterline length of the hull. The fin has arcuate cross sections that extend outwardly and downwardly in a curve from the hull to deflect water.

Another embodiment is a hull having a fin and further including wherein the fin is a thin member extending not more than half the hull length, the fin edge gradually extending outwardly from the hull to an outboard-most point, then receding toward the hull.

Another embodiment of the present invention is a hull having a buoyancy rail extending the majority of the length of the hull, wherein the buoyancy rail includes upper and lower surfaces that extend outwardly from the hull and form a deflection guard to deflect water, the buoyancy rail being located at or below the waterline, and the buoyancy rail adding buoyancy to the outboard edge of the hull when the hull is in a turn. The buoyancy rail has an effective volume between about 1-2% of the volume of the hull. The underside of the buoyancy rail can be formed from two longitudinal panels joined to each other. The inboard panel is inclined from the hull upwards and outwards at an angle of about 10 to 20 degrees from horizontal. The outboard hull panel is narrower than the inboard panel and is declining from the attachment location to the inboard panel downward and outward at an angle of about 1 to 8 degrees from horizontal.

Another embodiment of the present invention is a bait tank. The bait tank includes a container to hold liquid within the inner volume of the container. The bait tank includes a trough located behind at least one upper edge of the container. The bait tank includes a screen extending not more than half the height of the tank, the screen being interposed between the trough and the inner volume of the container.

Another embodiment of the present invention is an accessory storage system. The accessory storage system includes at least one board having a major surface. The board includes guides on the major surface arranged in a pattern that extends over the major surface. The accessory storage system includes a cord extending from guide to guide. The cord serves to store accessories, such as fishing tackle.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagrammatical illustration of a front view of a boat hull in accordance with one embodiment of the present invention;

FIG. 2 is a diagrammatical illustration of a front and bottom view of a boat hull in accordance with one embodiment of the present invention;

FIG. 3 is a diagrammatical illustration of a side view of a boat hull in accordance with one embodiment of the present invention;

FIG. 4 is a diagrammatical illustration of a rear and bottom view of a boat hull in accordance with one embodiment of the present invention;

FIG. 5 is a diagrammatical illustration of a front view of a boat hull in accordance with a second embodiment of the present invention;

FIG. 6 is a diagrammatical illustration of a front and side view of a boat hull in accordance with a second embodiment of the present invention;

FIG. 7 is a diagrammatical illustration of a side view of a boat hull in accordance with a second embodiment of the present invention;

FIG. 8 is a diagrammatical illustration of a cross-sectional view of a fin in accordance with one embodiment of the present invention;

FIG. 9 is a diagrammatical illustration of a cross-sectional view of a buoyancy rail in accordance with one embodiment of the present invention;

FIG. 10 is a diagrammatical illustration of a cross-sectional view of a buoyancy rail in accordance with one embodiment of the present invention;

FIG. 11 is a diagrammatical illustration of a bait tank in accordance with one embodiment of the present invention;

FIG. 12 is a diagrammatical illustration of a cross-sectional view of a bait tank in accordance with one embodiment of the present invention; and

FIG. 13 is a diagrammatical illustration of an accessory storage system in accordance with one embodiment of the present invention.

### DETAILED DESCRIPTION

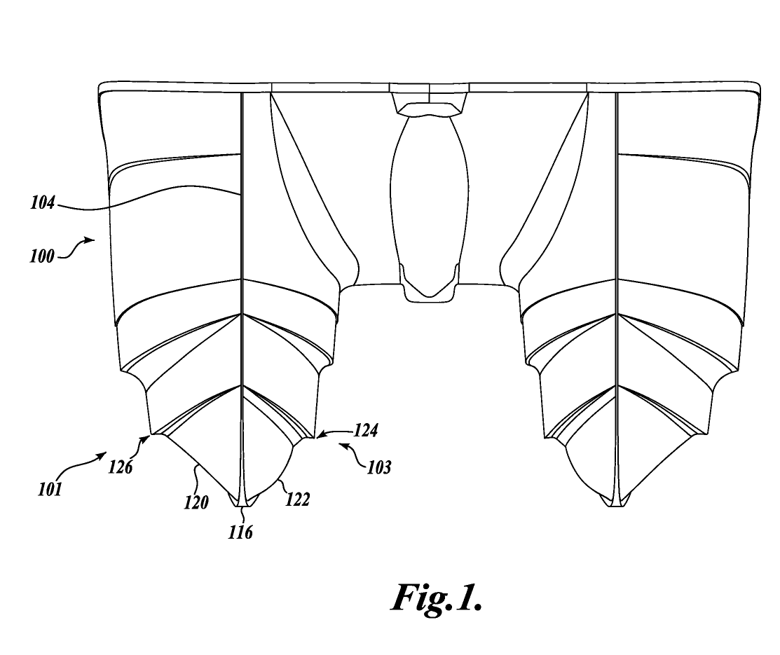

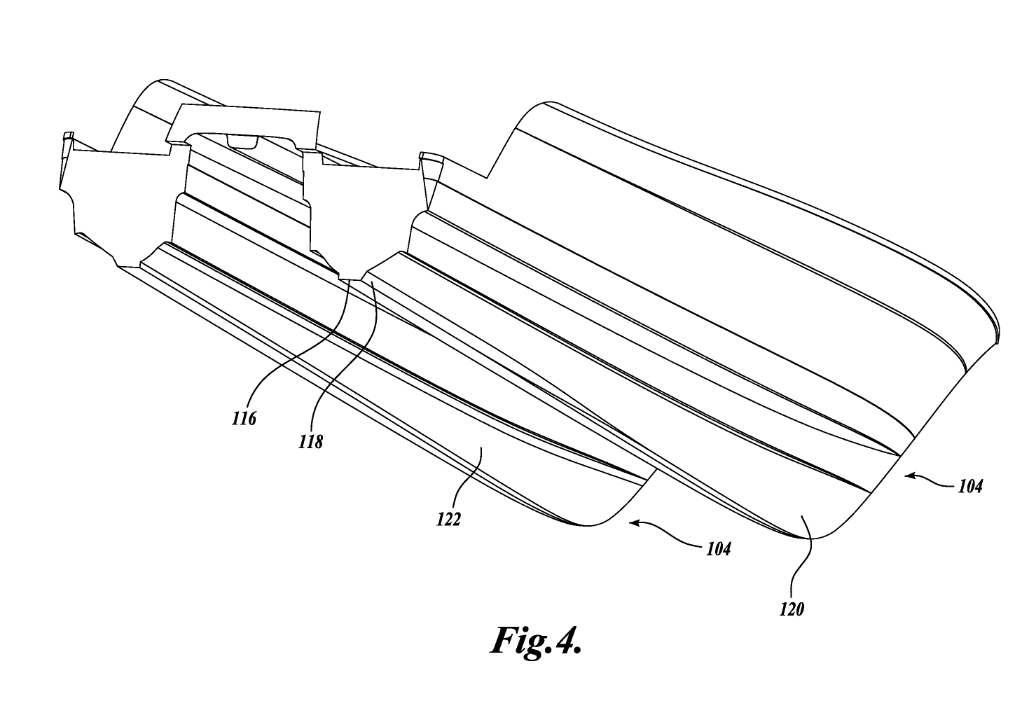

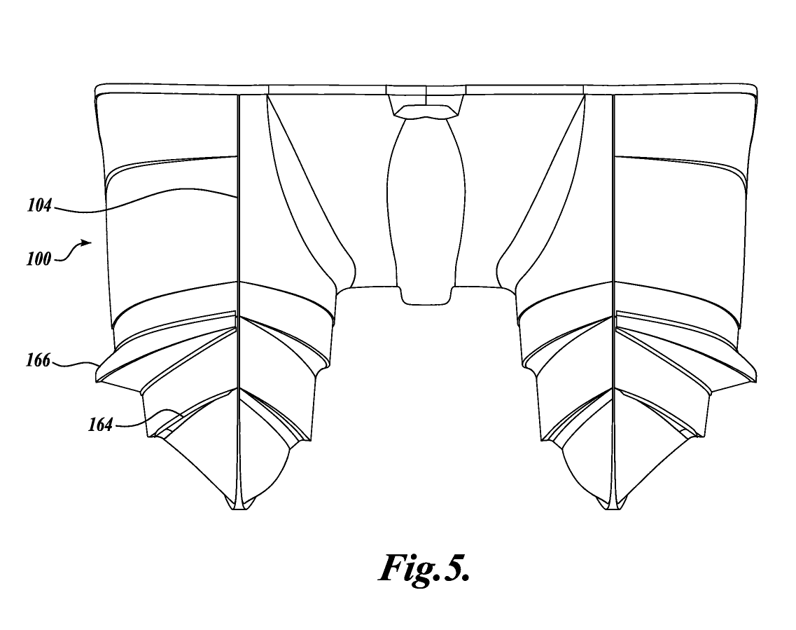

Referring to FIGS. 1-4, a hull 100 in accordance with one embodiment of the invention is illustrated. The hull 100 or any one of the features described herein can be used independently of any other feature or in combination with one or more features in any multihull, power watercraft. The hull 100 combines both displacement-type properties and planing-type properties in a single hull. While the figures illustrate a powered double-hulled watercraft, the hull 100 or any of its features can be incorporated into any multihull design, power watercraft. It is to be appreciated that the description of the hull used in a catamaran-type watercraft is merely exemplary of one embodiment of the invention.

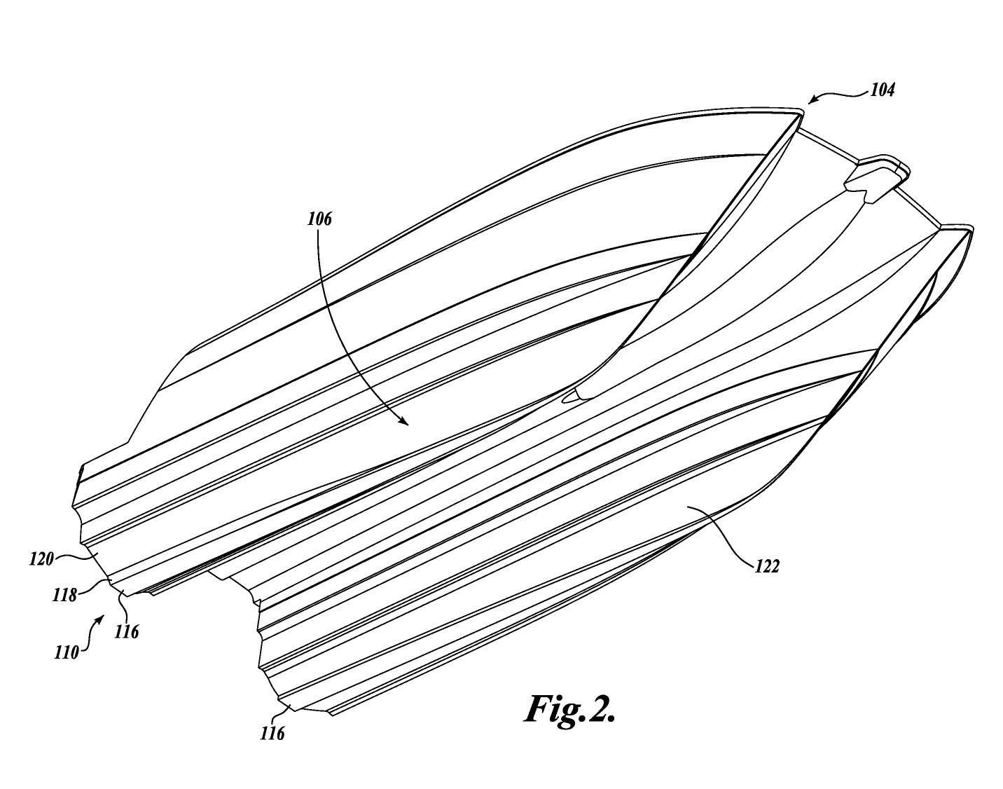

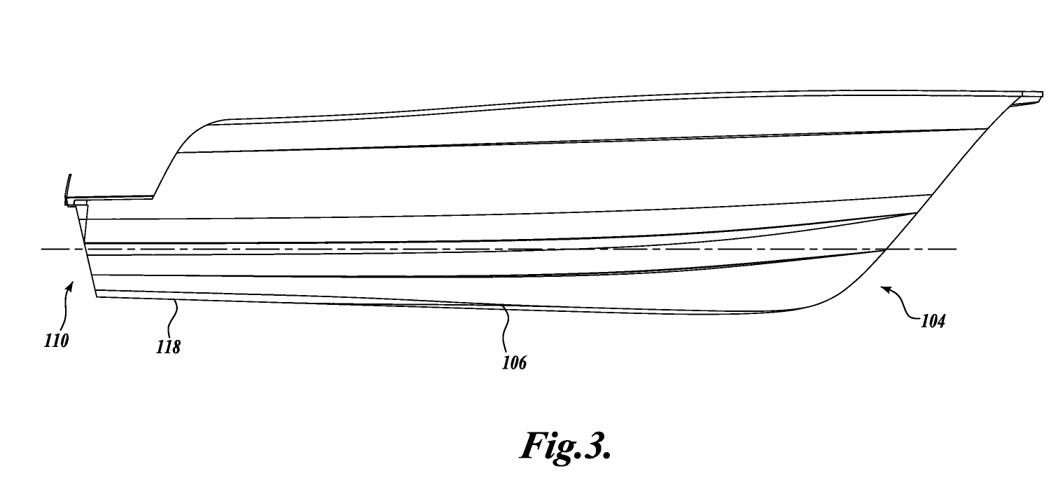

Referring to FIG. 2, the boat hull 100 in accordance with one embodiment of the present invention is illustrated. The hull 100 includes an outboard planing hull section 120. The hull 100 also includes an inboard displacement hull section 122. The lowermost feature of the hull 100 is the keel 116. The keel 116 includes a flat portion at the very bottom of the keel 116. The keel 116 extends longitudinally from the stern 110 to the lowermost section of the bow 104 in a wedge as seen in FIG. 2. The keel 116 width can diminish gradually from stem 110 to bow 104. On the outboard side 101, the hull 100 includes a transition panel 118. The transition panel 118 on the outboard edge runs outwardly and upwardly at approximately 40 to 50 degrees from vertical from stern 110 to amidships 106 from the keel 116 The transition panel 118 provides additional stability while banking. The transition panel 118 has its greatest height at the stern 110 and the height is constant moving toward amidships 106 or can be gradually diminishing from the stern 110 toward amidships 106, so that the transition panel 118 defines a narrow wedge from stern 110 to amidships 106 when viewed from the side as in FIG. 3. The transition panel 118 terminates at or about amidship 106.

To best describe the features of the hull 100, reference is made to FIGS. 1 and 2. The hull 100 includes an inboard side 103 and an outboard side 101. The planing surface 120 on the outboard side 101 runs fore and aft from the stem 110 to the lower section of the bow 104, and side to side from the keel 116 and transition panel 118 to the chine 126. The chine 126 can include a flat panel that is approximately horizontal. The displacement surface 122 on the inboard side 103 runs fore and aft from the stem 110 to the lower section of the bow 104, and side to side from the keel 116 to the chine 124. The chine 124 can include a flat panel that is approximately horizontal.

As seen in FIG. 1, the displacement surface 122 on the inboard side 103 differs from the planing surface 120 on the outboard side 101. The displacement surface 122 has an arcuate or inside-radiused configuration, meaning that the center of the radius of curvature lies at a point toward the hull 100, while the planing surface 120 has less of an arcuate shape and is approximately planar.

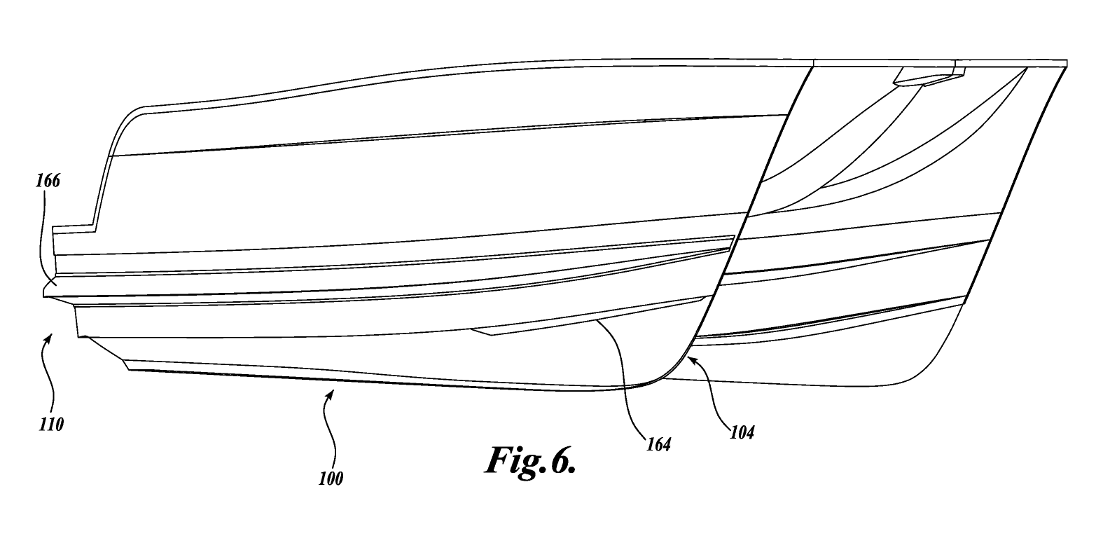

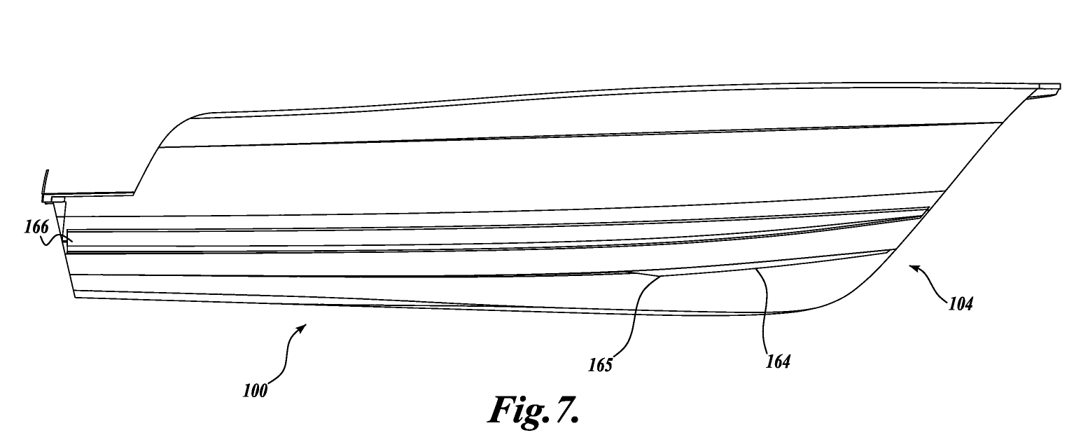

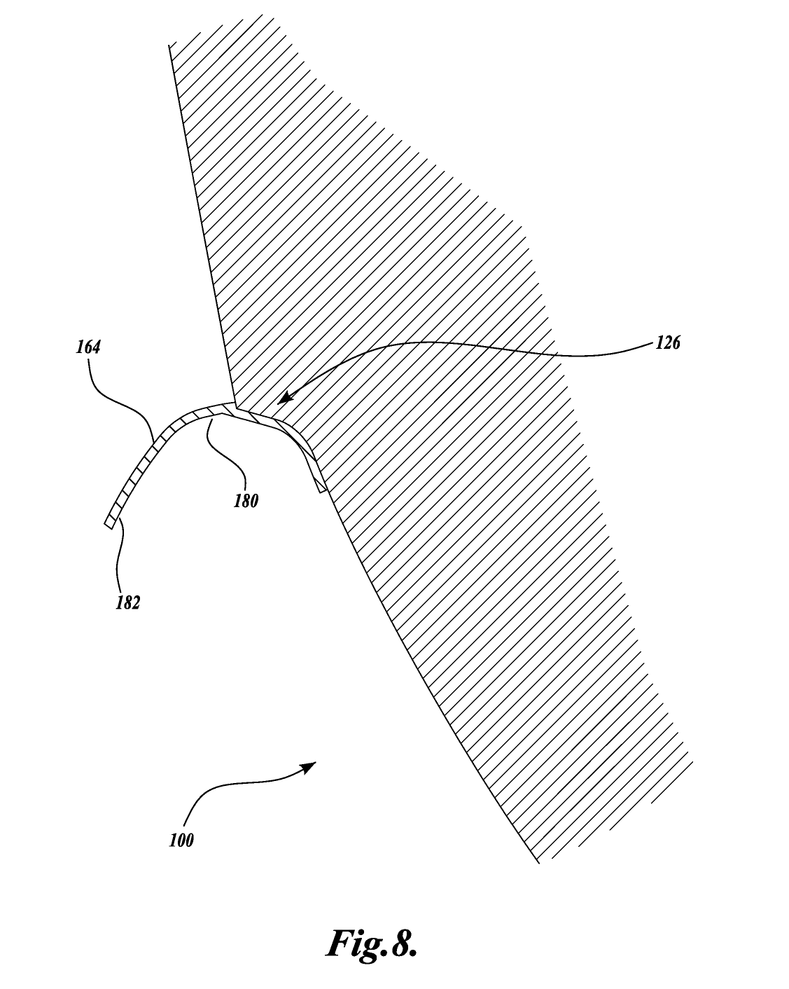

As seen in FIGS. 6 and 7, a fin 164 is another embodiment of the invention. A fin 164 is provided from the bow 104 extending toward the stern 110. The fin 164 is mounted to the hull 100 on the outboard side, but not the inboard side. The fin 164 is mounted along the longitudinal plane of the outboard side of the hull 100, near to or just below the waterline and extends aft from the bow for up to 40% of the waterline length of the hull 100. The width of the fin 164 gradually extends or increases in width from the bow 104 toward the stem 110. The width is greatest at a point 165 close to the termination of fin 164 and then rapidly decreases in width, as seen in FIG. 7. A cross section of the fin 164 is illustrated in FIG. 8. The fin 164 is formed to have cross sections similar to FIG. 8 throughout the majority of the length of the fin 164. The entry angle 180 is nearest to the hull 100, while the exit angle 182 is at the outboard-most edge of the fin 164. Such configuration extends along the majority of the length of the fin 164. The arc length of the fin 164 from bow 104 toward the stern 110 gradually increases to the point 165 as seen in FIG. 7. The cross-sectional shape of the fin 164 is a thin blade that directs water from the hull 100 in a downward and outboard direction. The thinness of the fin 164 allows the fin 164 to pierce through the water with minimal drag while redirecting the flow of water. The fin 164 improves tracking stability for boats.

Many factors affect how straight a boat runs without correction from the steering wheel including, but not limited to, the longitudinal center of gravity, windage area above the waterline, centroid of the underwater lateral plane, and hull form. By modifying any one of these factors, their collective effect on tracking is changed. The fin 164 alters the hull form factor in a manner that can be understood by comparing it to automobile tracking. On an automobile, one way to improve tracking is to adjust the wheel alignment. When castor, camber, and toe-in are all set properly, the result is predictable tracking and handling. In the same way, hull form has an effect on tracking and handling. The dynamic “grip” at the bow and the balance of side load generated by water flow affects the “alignment” of the hull.

The fin 164 is a method and means for directing water against the underside of the fin 164 to create an outwardly directed force and to create a low pressure shadow above the fin 164 which also creates an outwardly directed force. These forces tend to want to drive the hull to the outside. These forces can be likened to an adjustment in toe-in on an automobile and greatly affect the tracking capability of the hull. The size and length of the fin 164 are determined empirically for each boat. The fin 164 has the greatest effect at its furthest point from the vessel's center of gravity because of the increase in moment arm. Thus, a preferred location for the fin 164 is at the bow 104 of the hull 100. This feature functions on all planing and high speed displacement vessels and both mono-hulls and multi-hulls.

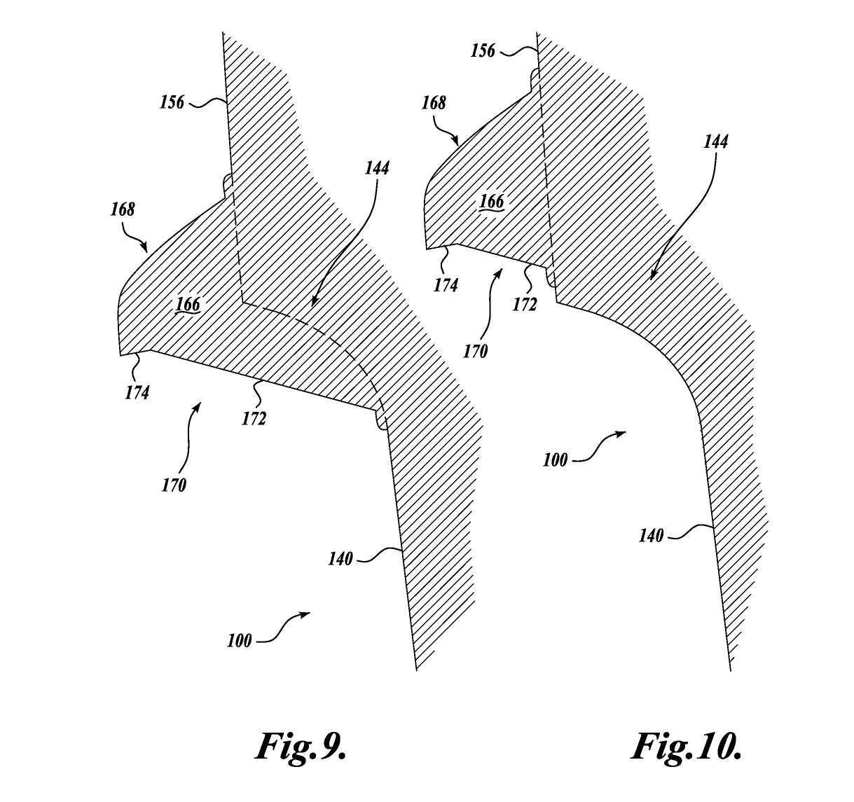

Referring to FIGS. 6 and 7 again, an additional feature of the hull 100 is illustrated. The hull 100 includes a buoyancy rail 166. The buoyancy rail 166 is another embodiment of the invention. The buoyancy rail 166 may extend from the bow 104 to the stem 110. However, depending on the length of the hull 100, the buoyancy rail 166 may extend less than the entire hull length and may terminate before reaching the bow 104. The buoyancy rail 166 can be positioned at an outboard upper chine 144 (FIG. 9) or immediately above the outboard upper chine 144 (FIG. 10). The buoyancy rail 166, when viewed in the cross-sectional illustrations of FIGS. 9 and 10, has an upper surface 168 extending outward and downward from an outboard top hull panel 156 of the hull 100 and a lower surface 170 extending outward and upward from an outboard middle hull panel 140 of hull 100 as shown in FIG. 9, or from the outboard top hull panel 156 as shown in FIG. 10. The buoyancy rail is formed from substantially similar cross sections throughout its length. The lower surface 170 includes an inboard panel 172 and an outboard panel 174 that extend longitudinally on the lower surface 170. The inboard panel 172 is inclined approximately 10 to 20 degrees with respect to the horizontal so that the outboard edge of the inboard panel 172 is at a greater elevation than the inboard edge of the inboard panel 172. The outboard panel 174 is connected to the outboard edge of the inboard panel 172. The outboard panel 174 can be horizontal or, in the embodiment illustrated, the outboard panel 174 is declined from the horizontal approximately up to 10 degrees so that the outboard edge of the outboard panel 174 is lower than the inboard edge of the outboard panel 174. The upper surface 168 of the buoyancy rail 166 extends downwardly and outwardly initially at about a 45 degree angle with respect to the horizontal so that the outboard edge is lower than the inboard edge where the buoyancy rail 166 connects to the hull 100. The upper surface 168 sharply curves downward substantially vertically so as to join with the outboard edge of the outboard panel 174. The volume of the buoyancy rail 166 is substantial so as to increase the buoyancy of the hull 100 when a turn is executed. Such volume can amount to 1-2% of the hull volume. The buoyancy rail 166 is a method and means for providing stability in two ways while turning—firstly, by increasing the buoyancy and, secondly, by generating dynamic lift. As the boat rolls, the angled underside gradually rises above the waterline, providing a smooth reduction of lift on the side of the boat that does not need the extra lift. In addition, the underside of buoyancy rail 166 provides spray deflection at the point of generation. Lastly, the buoyancy rail 166 generates lift and deflects spray without the rough ride of a wider hull because the shape pierces through the larger waves.

The methods for making the hull 100 with the lower and upper chines and hull panels may include, for example, preparing a mold having the negative of the features as described above, so that the features are transferred to the hull. Alternatively, for wood or other materials, the above-described features can be shaped from stock materials and glued on or otherwise attached to the hull. Additionally, features, such as the buoyancy rail and fin may be difficult to form from the same mold as the hull. The fin and buoyancy rail can be cast from a different mold and then mounted with fasteners or adhesives to the hull 100. Alternatively, the fin and buoyancy rail can be cast together with the hull by using a mold that can be taken apart to facilitate removal from the mold.

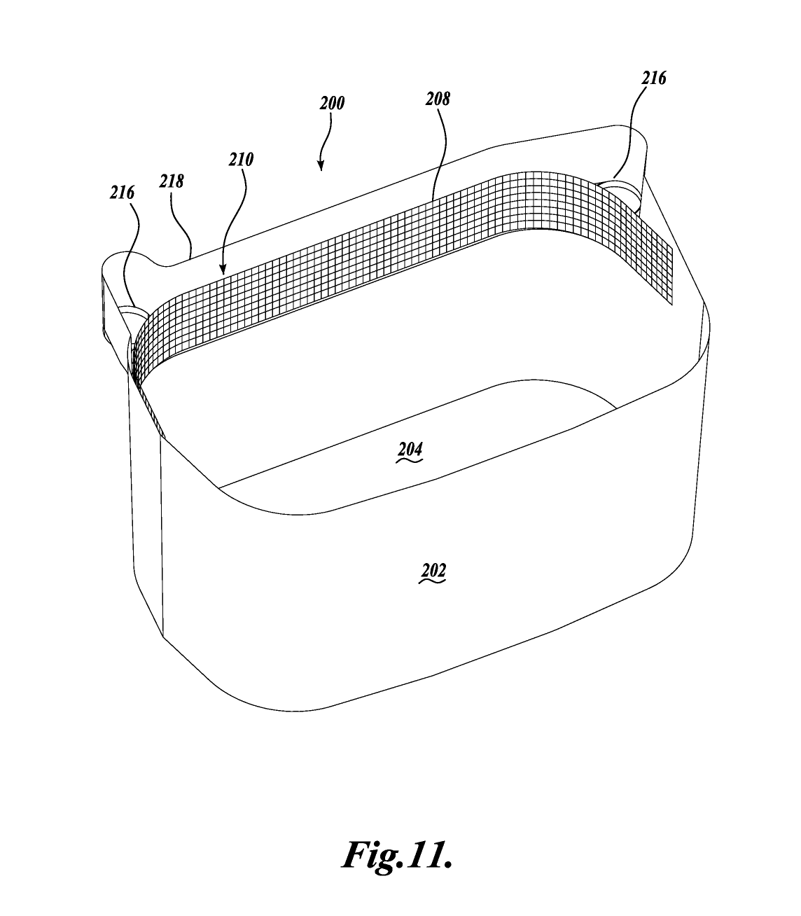

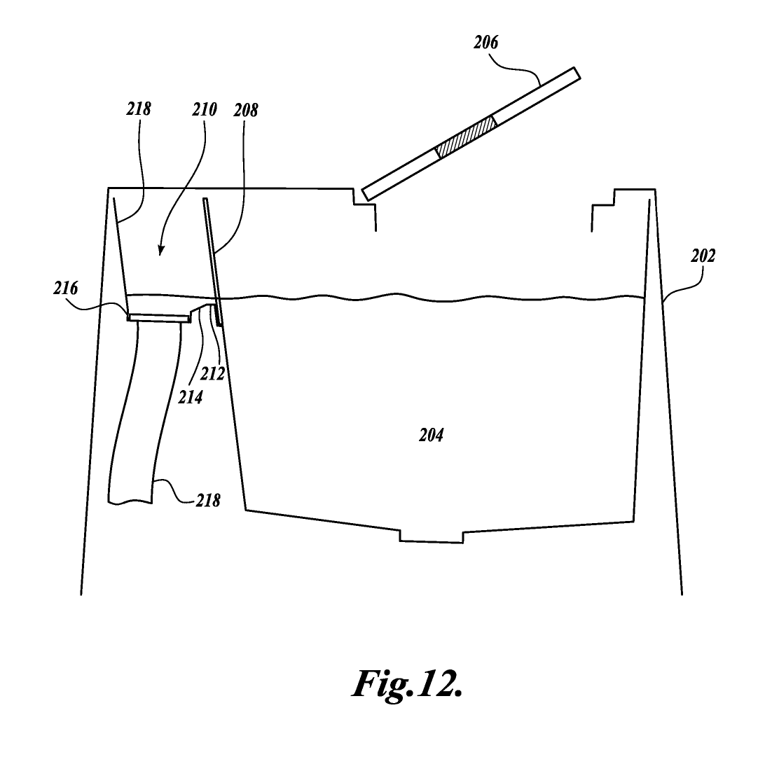

Referring to FIGS. 11 and 12, an overflow drain system 200 for aquatic organisms and method for use onboard recreational fishing boats and like watercraft is illustrated. The drain system includes a live well tank 202. The live well tank 202 is a container including side walls and a bottom to hold a reservoir of liquid 204. The liquid 204 is the natural habitat for the aquatic organisms, such as live bait. A cover 206 can be hinged to one of the walls of the live well tank 202. Any other suitable configuration for the cover 206 to provide access to the interior of the live well tank 202 can be used. The tank 202 includes a screen 208 provided at the upper edge of the tank 202 so that the screen 208 is at the height of the liquid 204 so that liquid 204 can flow through the screen 208. The screen 208 may rest on a lip created into the upper section of the wall or may be held by other means. Behind the screen 208, a trough 210 is provided to receive the liquid 204 that flows through the screen 208. From the screen 208, the trough 210 has a slight horizontal run 212 followed by an inclined run 214 leading to the drain 216. The height of run 212 generally determines the liquid level. Behind the drain 216, a trough wall 218 extends to about the height of the opposite wall on the opposite side of the tank 202. The area between the back wall 218 of the trough 210 and the screen 208 collects the liquid 204, which runs into the drain 216 and out of the trough 210 through the hose 218. Referring to FIG. 11, the screen 208 can be provided on one or more of the walls of the tank 202. The screen 208 can extend vertically at least to the bottom of the trough 210. The trough 210 extends generally about the same length as the screen 208 so that any liquid 204 passing through the screen 208 is collected behind and in the trough 210. One or more drains 216 can be provided according to the size and diameter of the drains 216.

Spreading the liquid drainage across the entire surface of the screen 208 eliminates suction points and harmful protrusions, which may injure aquatic organisms, used in existing bait tanks, thereby simulating a realistic aquatic habitat.

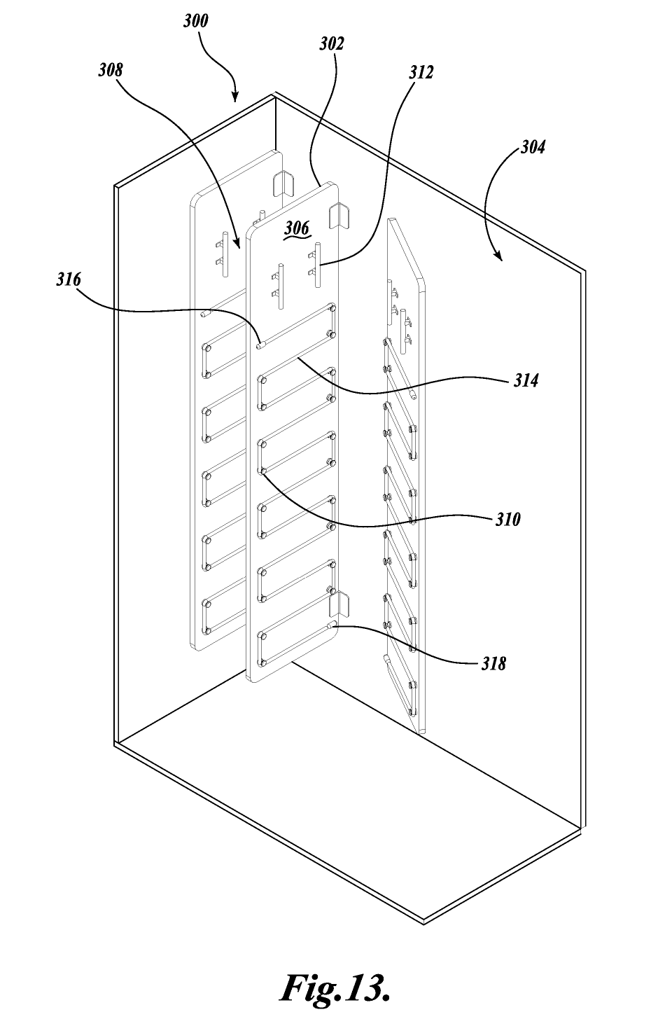

Referring to FIG. 13, an accessory storage system 300 is illustrated. The accessory storage system 300 includes one or more boards 302 hinged to a wall 304 within a compartment or in the open. The board 302 has a first major surface 306 on one side and a second major surface 308 on the opposite side. One or both of the major surfaces is provided with a plurality of knobs 310, which function as guides as described below. Additionally, one or both major surfaces may include cleats 312. In one embodiment, the knobs or guides 310 are arranged along two columns from top to bottom to utilize as much of the major surface as possible. The elastic cord 314 is anchored to the board 302 at its ends 316 and 318. The cord 314 is routed directly across to the knob corresponding to the height of the anchor point 316 or 318. The cord 314 passes over the first knob, is then routed downwardly (or upwardly) to the second knob directly in line below (or above) the first knob, where it passes under (or over) the second knob. Then, the cord 314 is routed to the third knob on the edge of the board 302 opposite to the edge on which the second knob is located. The cord 314 passes over (or under) the third knob. The cord 314 continues to be routed in the manner described so that the cord 314 winds its way across, down, and across until the bottom (or top) of the board 302 is reached, where the cord 314 can be anchored to the board 302. The cord 314 serves to hold accessories for storage purposes, such as fishing lures, hooks, and other fishing tackle, for example. In one embodiment, the board 302 may include cleats for the storage of mooring or docking lines, fishing lines, and cords of all kinds.

In one embodiment, the board 302 can be provided vertically standing or, alternatively, the board 302 may be horizontally disposed. In one embodiment, more than one board can be arranged in a book-style fashion, so that boards 302 are hinged to a central post or wall 304 and the boards 302 can be open and closed, like pages in a book. The boards 302 can be enclosed within a compartment of a boat hull. Alternatively, the boards 302 can be out in the open.

In other configurations, the knobs 310 can be arranged differently, so that knobs 310 can be spaced closer to one another or further apart. For example, the major surface 306 of the board 302 can include a plurality of vertically and horizontally closely spaced holes so that a user can determine the position where to insert the knobs 310 to select the routing of the cord 314.

The embodiments of the invention in which an exclusive property or privilege is claimed are defined as follows:

1. A multihull watercraft, comprising:
(a) a hull having an outboard side and an inboard side, a keel at the bottom of the hull, and a stern and a bow at opposite ends of the hull;
(b) a first lower hull panel on the outboard side of the hull and above the keel, wherein the first lower hull panel has approximately planar cross sections along a portion of the length of the hull to provide planing characteristics on the outboard side of the hull; and
(c) a second lower hull panel on the inboard side of the hull and above the keel, wherein the second lower hull panel has a radius of curvature at cross sections along a portion of the length of the hull to provide displacement characteristics on the inboard side of the hull.

2. The hull of claim 1, wherein the inner edges of the first and the second lower hull panels are separated by the keel, wherein the keel diminishes in width from the stern to the bow.

3. The hull of claim 1, wherein the outer edges of the first and the second lower hull panels terminate in flat chine panels, wherein the chine panels are approximately horizontal.

4. The hull of claim 1, wherein the keel and the lower outboard hull panel are joined by an angled transition panel that extends from the stem towards amidship, the angled transition panel diminishing in size to the termination of the transition panel at about amidship.

5. A hull, comprising a fin extending from the bow toward the stern on a hull side, the fin having arcuate cross sections along the majority of the length of the fin, wherein the fin cross sections extend outwardly and downwardly in a curve from the point of attachment to the hull side.

6. The hull of claim 5, wherein the fin is a thin member extending not more than half the hull length, the fin edge gradually extending outwardly from the hull to an outboard-most point, then receding toward the hull.

7. A hull, comprising a buoyancy rail mounted to a hull side and extending the majority of the length of the hull, the buoyancy rail comprising upper and lower surfaces that extend outwardly from the hull, the buoyancy rail being located at or below the waterline.

8. The hull of claim 7, wherein the buoyancy rail has a volume that is about 1 to about 2 percent of the volume of the hull without the buoyancy rail.

9. A bait tank, comprising:
(a) a container to hold liquid within the inner volume of the container;
(b) a trough located behind one upper edge of the container and extending along the upper edge; and
(c) a screen between the trough and the inner volume of the container, wherein the screen extends for the majority of the length of the trough.

10. An accessory storage system, comprising:
(a) a board having at least one major surface;
(b) guides on the major surface of the board arranged in a pattern; and
(c) a cord extending from guide to guide to provide storage for accessories.

11. The accessory storage system of claim 10, wherein the guides are positioned on the board in substantially a first and second vertical line, wherein one guide on the first vertical line corresponds approximately to one guide on the second vertical line.
